(19) United States
(12) Patent Application Publication
(10) Pub. No.: US 2003/0208547 A1
(43) Pub. Date: Nov. 6, 2003

(54) Direct internet mail access through links in wireless instant messaging systems

(76) Inventor: Ambrekovic Branimir, Zagreb (HR)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 10/426,465

(22) Filed: Apr. 30, 2003

Related U.S. Application Data
(60) Provisional application No. 60/377,261, filed on May 1, 2002.

(51) Int. Cl. G06F 15/16

(52) U.S. Cl. 709/206; 709/203

(57) ABSTRACT

A method and system enabling the user of a wireless device to remotely access a modified version of an Internet email message through a link provided in a low bandwidth message transmitted to the wireless device.

### CROSS-REFERENCE TO RELATED APPLICATIONS

This application is based upon and gains priority from U.S. Provisional Patent Application Serial No. 60/377,261, entitled “Direct Internet Mail Access Through Links in Wireless Instant Messaging Systems”, filed with the U.S. Patent and Trademark Office on May 1, 2002 by the inventors herein, the specification of which is incorporated herein by reference.

### BACKGROUND OF THE INVENTION

1. Field of the Invention

The invention comprises a method and system for distributing electronic mail to wireless devices, and more particularly to a method and system enabling the user of a wireless device to remotely access a modified version of an Internet email message through a link provided in a low bandwidth message transmitted to the wireless device.

2. Description of the Background

Wireless telephone technology is widespread among today's consumers, affording persons at remote locations the ability to keep in touch with those who might need to reach them while they are on the go. The demand for such remote accessibility has risen to a demand for remote access to email through a wireless device that the user already has, such as a cellular telephone, and attempts have been made to enable such remote access. Currently, the only services enabling a user to access their e-mail by using a cellular telephone carry too many obstacles and limitations to be widely accepted and implemented. For instance, currently available cellular telephone email systems require the user to use a WAP browser and login to a WAP enabled front-end in order to access their Internet mail system. This process is too complex because the average user doesn't even know how to point a WAP browser to a WAP enabled front end. Moreover, requiring the user to login by entering their username and password is inconvenient and excessively complex when the data entry device is a cell phone.

Moreover, only a handful of Internet mail servers support WAP or i-Mode enabled access to POP3 and IMAP mailboxes. Most of them do not offer such support.

Still further, WAP access to Internet mail cannot display HTML formatted messages, attachments, etc.

Telecommunication companies also arrange the forwarding of Internet mailbox contents to cell phones in the form of SMS, EMS, or MMS. This way, the user can only access e-mail that is stored in a mailbox residing with the wireless provider. Ordinarily, the user cannot access a corporate mailbox, an ISP mailbox, or a private mailbox via the cell phone. Still further, the message forwarded to SMS is cut down to only 160 characters, thus essentially cutting out all of the content from the e-mail except for the subject line. Lastly, no formatting or attachments are visible in such a message.

Thus, there remains a need to provide a method and system capable of allowing a user to employ their wireless device to remotely access their email while avoiding the disadvantages associated with the prior art systems and methods.

### SUMMARY OF THE INVENTION

The above disadvantages are overcome by the system and method of the invention described herein, which in one embodiment provide instant notification of received Internet email messages by forwarding a subject and a link to the full message via SMS, EMS or MMS. Such system and method enables access to virtually any Internet e-mail system supporting POP3 or IMAP, and is capable of providing WAP and a wireless front end to existing Internet mail systems “on-the-fly.” The user doesn't need any information concerning how to hook up to their mailboxes through their respective wireless devices (WAP, etc.). Rather, the user merely needs to click on the link embedded in the regular SMS, EMS or MMS received. Moreover, the user doesn't have to login to access e-mail safely and securely. Rather, the link embedded in the SMS, EMS or MMS and front end service ensure identity and access rights. Such a method and system are extremely easy to use for the end user, and the service dramatically increases the use and data traffic of wireless internet, thus providing for significant increase in revenues for wireless operators (2G, 2.5G and 3G).

### DESCRIPTION OF THE DRAWINGS

FIG. 1 is a schematic view of a system for distributing electronic mail to wireless devices according to the instant invention.

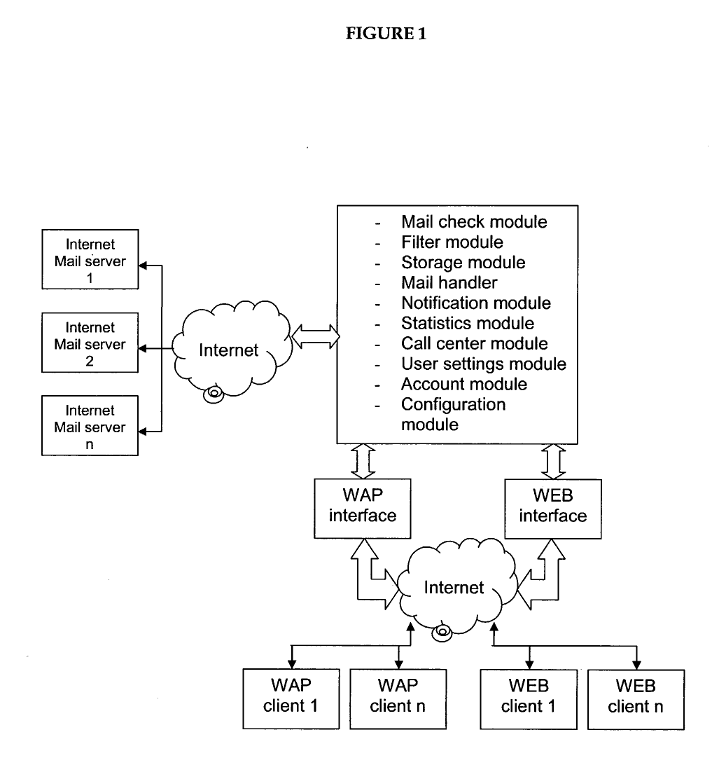

FIG. 2 is a schematic representation of a computer server implementing the methods of the instant invention.

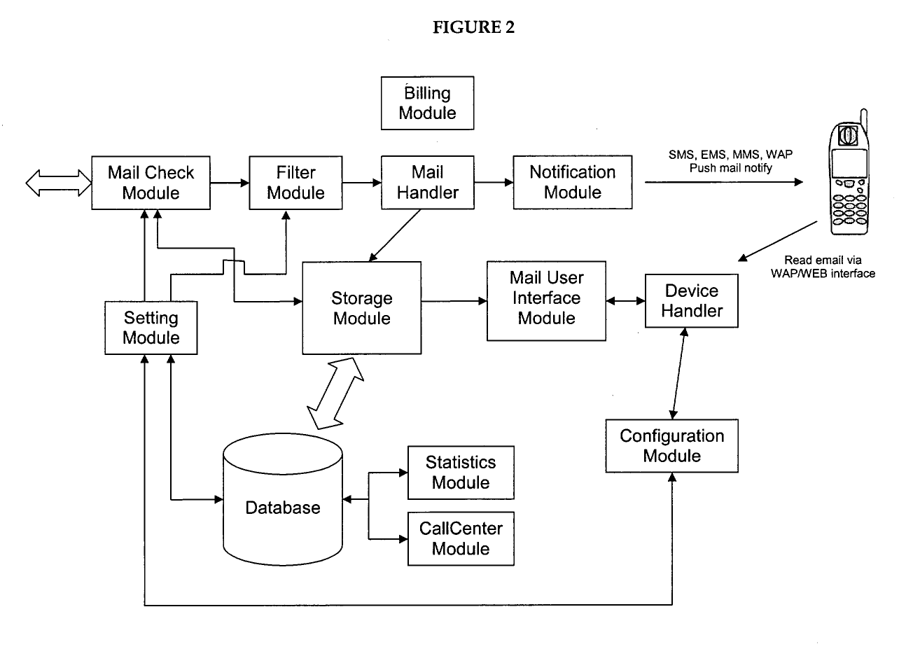

FIG. 3 is a flow chart depicting the transfer and processing of a message from an Internet mail server to a wireless client device according to a method of the instant invention.

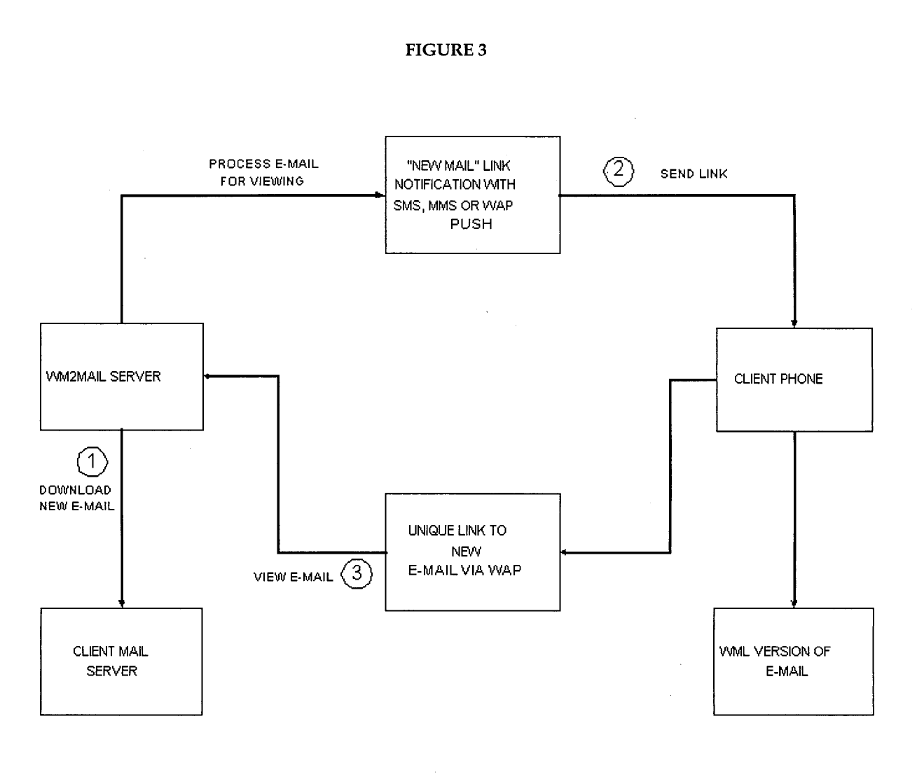

FIG. 4 is a flow chart depicting the process of receiving a new email from an Internet mail server and forwarding an instant message notification email to a wireless device.

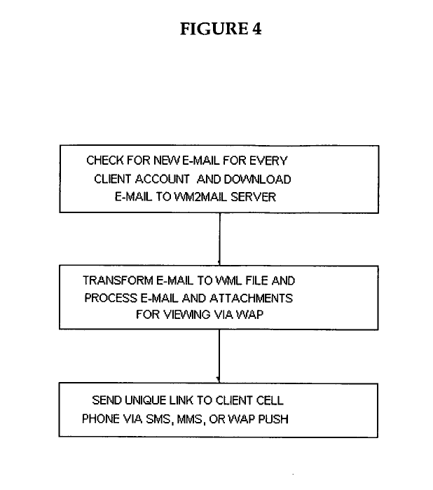

FIG. 5 is a flow chart depicting the transfer of data between server 10 and external elements when implementing a method of the instant invention.

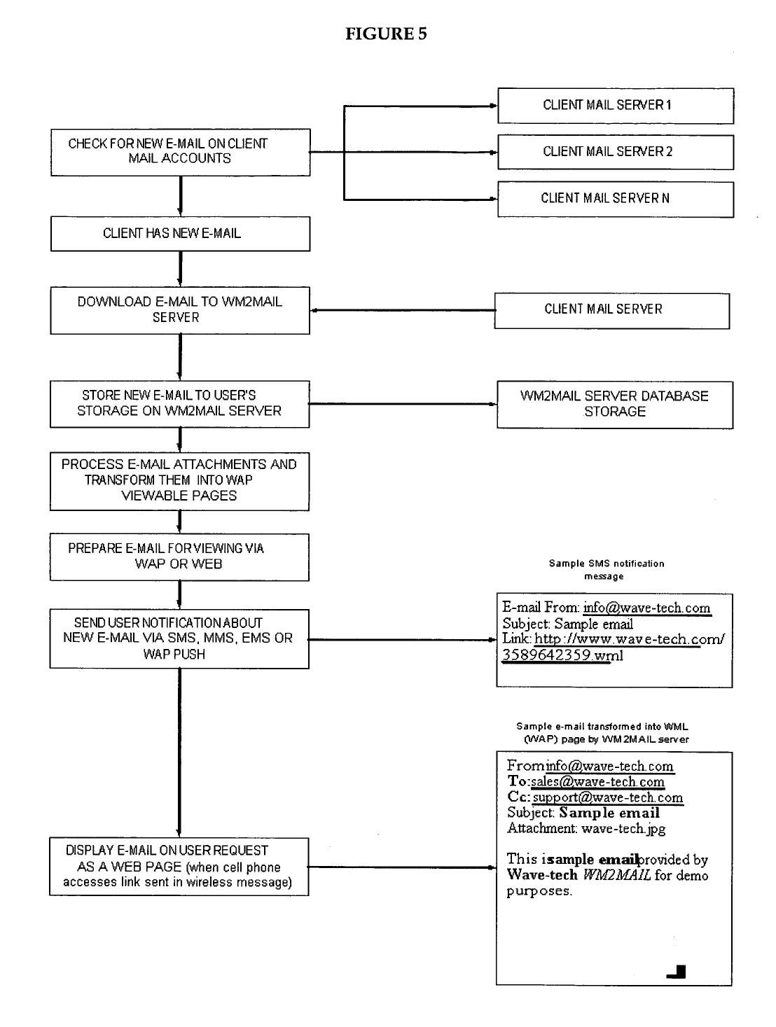

FIG. 6 is a flow chart depicting the server function of obtaining new email from Internet mail servers according to a method of the instant invention.

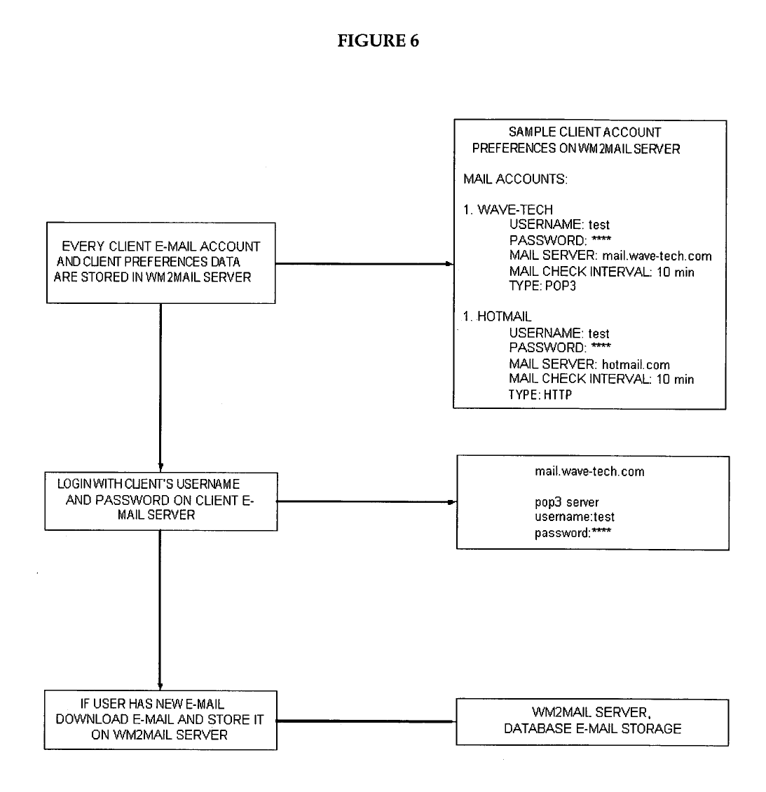

FIG. 7 is a flow chart depicting the server function of creating a modified mail message based upon an original Internet email message according to a method of the instant invention.

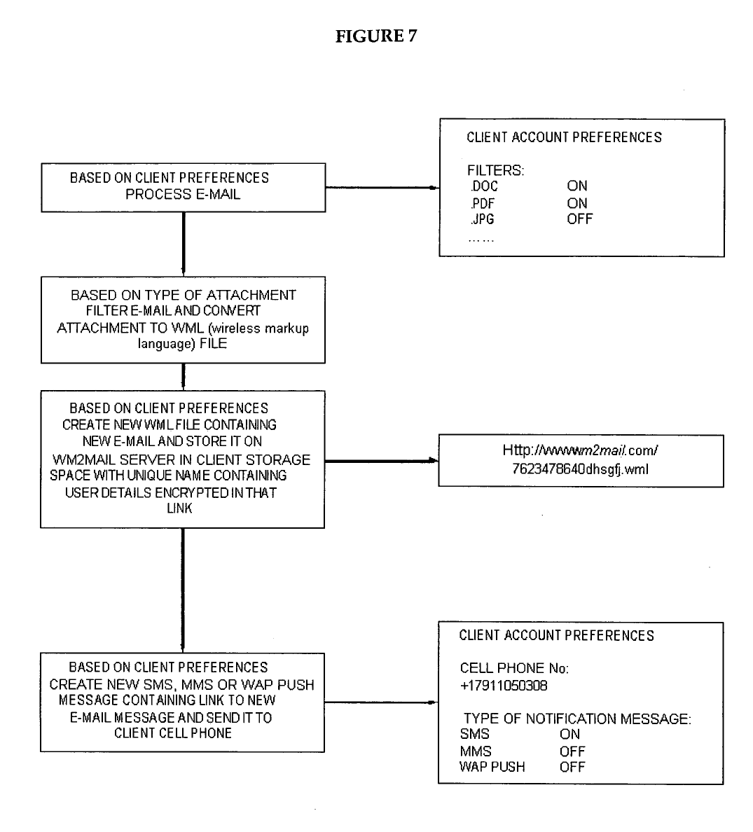

### DETAILED DESCRIPTION OF THE PREFERRED EMBODIMENTS

The system comprises a remote server 10, for example a WINDOWS-based server built around a Pentium CPU, a Sun Fire Server running Solaris or a Linux platform, or any other similarly capable computer platform equipped to communicate with a wide area network (such as the Internet), a local area network, an intranet, or the like. Server 10 is also equipped to communicate with a plurality of wireless machines 30, such as wireless telephones, pagers, personal data assistants, portable computers, and the like. The server performs functions to receive Internet Mail from Internet Mail Servers, process received mail into a modified message which is stored in a format in which the message and any attachments thereto may be read, viewed, heard, and otherwise accessed on a wireless client machine, transmit a summary of a particular received Internet Mail message (with a link to the specific modified message) to the intended wireless client machine, and communicate with the wireless client machine to allow secure access from that wireless client machine to the modified message without requiring a logon procedure by the user.

A plurality of Internet Mail Servers 20 manage the reception, storage, and transmission of Internet email using the well-known POP3 (Post Office Protocol 3) and IMAP (Internet Message Access Protocol) mail protocols, as is known in the art. Internet Mail Servers 20 transmit newly received Internet mail messages to server 10. The transfer of Internet mail messages from Internet Mail Servers 20 to server 10 may be carried out in a number of ways. First, server 10 may check for newly arrived Internet email on mailboxes housed on individual servers 20 at regular time intervals. To effect the transfer of email from Internet Mail Servers 20 to server 10 in this fashion, a wireless service subscriber may, at the time of subscribing to the services administered by server 10, provide a listing of all Internet mail accounts from which they wish to receive mail on their wireless device. Such listing of Internet mail accounts is then written to a database file on or in communication with server 10, and is particularly identified to server 10 as corresponding to that user's wireless account. Alternately, a Java applet may be used to fetch from an end-user's PC information about mail accounts from MS OUTLOOK or other similarly configured mail management programs. Once a subscriber's Internet mail accounts have been identified to server 10 and written to the database file, a mail check module (described in greater detail below) may regularly query the Internet mail servers 20 listed for that wireless user's profile stored on the database at any desirable time interval, transmitting to the server the ordinary login information (e.g., username and password) required by that Internet mail server to access the intended wireless user's Internet mail account. Once communication is established between server 10 and the intended Internet mail server(s), server 10 determines whether new mail messages are present on the Internet mail server. Server 10 first reads all date and time fields and message identifications and compares them against a list on server 10 of all messages that have been previously processed. All messages that have not yet been processed by server 10 are then retrieved from server 20, and processed from the local storage on server 10. Thus, server 10 simply acts as a conventional mail client, such as MS OUTLOOK, and retrieves a copy of the original email message from server 20, storing such copy in a database file on or in communication with server 10. Alternately, if a user's mail server supports “forward copy”, and the wireless user has instructed his Internet mail server to automatically forward copies of all newly received email messages to server 10, a copy of the message will be instantly forwarded to server 10 upon its reception at Internet mail server 20. Clearly, server 10 may access a plurality of Internet Mail Servers 20 independently of one another, on behalf of one user or a multitude of users, so long as each server and each individual mail user on each server is identified in advance in server 10's user database.

Upon reception of a new Internet mail message, server 10 processes the mail message into a form in which the message may be viewed by a remote, wireless client machine 30, and stores such modified email message in a database on or in communication with server 10. More particularly, server 10 processes the received email message into a page that may be transmitted to and viewed by a wireless machine implementing a Wireless Application Protocol (WAP) enabled browser or a traditional HTML enabled browser.

To accomplish this conversion, the user preference file for the intended recipient of the email message is checked to determine whether the particular user's wireless device supports an HTML-enabled browser or a WAP-enabled browser. Depending upon the type of browser, the text body of the email message is formatted as either an HTML or WAP document, which document may be viewed by the appropriate HTML or WAP enabled browser running on a client wireless device. The HTML or WAP document is then stored in a database on or in communication with server 10, along with an identifier of the intended recipient. Also associated with the HTML or WAP document (either as a part of the same file or as a link between the HTML or WAP document and the original email message copy received on server 10) is the sender's email address, the recipients' email addresses, the text of the subject line, and the file name of any attachments to the original email message transmitted to server 10 from Internet mail servers 20, all of which items are ultimately nested together in a single HTML or WAP document viewable on a wireless client device 30, as further detailed below.

Further, if the original email message stored on server 10 includes an attachment, server 10 attempts to translate such attachment into a form that is accessible on the wireless device, again depending on the user's preferences. More particularly, upon subscribing to the services offered by server 10, a user is presented a listing of possible file attachment types that server 10 is equipped to translate into a form suitable for accessing from a wireless device. For example, the list of file types presented to the user may include “.DOC” (MICROSOFT WORD file types), “.PDF” (ADOBE ACROBAT file types), “.JPG” (graphic files), etc., and the user may select “ON” or “OFF” for each file type listed. If a user selects “ON” for a certain file type, attachments to email messages received for that user on server 10 will be processed by a software plug-in module capable of reading the attachment and translating the information into a form that may be presented on a wireless client device, e.g., converting a “.JPG” file to a bitmap file, converting a “.DOC” file into ASCII text, etc., each of which may then be stored as a separate HTML or WAP document on server 10 and accessible via a link in the modified email message which itself is an HTML or WAP document, or alternately as part of the modified email message itself. Clearly, a large variety of file types maybe provided for in this fashion, each file type simply requiring a translation plug-in module translating the original document or file into a format presentable to the wireless device.

Once the Internet Mail Message has been received and translated into a WAP or HTML page file viewable on a wireless device, that file, along with any translated attachments thereto, is stored in a database accessible by wireless client machines 30. Each such file is in turn associated with a particular wireless customer, such that the translated files may be made accessible only to those wireless customers for whom the original message was intended.

More particularly, as mentioned above, each user's email account is particularly associated with a wireless device user who in turn has one or more unique wireless device telephone numbers or similar unique communications identifier. When the modified HTML or WAP email document is generated, it is given a unique file name and stored on server 10 at a particular address that is identifiable by a particular universal resource locator (“URL”). The URL is formatted as a link attached to the instant wireless notification message forwarded to the appropriate wireless client device when the new message is received. As the file name, and thus the URL, are entirely unique to the particular original email message, and because the instant wireless notification message is sent only to such wireless devices as have been identified by that user, no one but the intended recipient wireless device may retrieve the modified email message stored on server 10.

After the WAP or HTML page file has been so generated, server 10 transmits an instant wireless message to the appropriate wireless client machine 30. The message may be transmitted via any one of the several known methods of instant messaging to wireless devices, including but not limited to Short Message Service (SMS), Enhanced Message Service (EMS), Multimedia Message Service (MMS), or WAP Push, which allows content to be sent or “pushed” to devices by server-based applications via a Push Proxy. Any known communications method may be used to implement the transmission of the instant wireless message to the wireless client machine 30, such as simple communication between the server 10 and a digital cell phone, communication between server 10 and a telecommunications service provider's SMS, EMS, MMS, or WAP Push server, or any other known methods for transmitting messages to wireless devices.

The instant wireless message transmitted to wireless client machine 30 serves as merely a notification of newly received email, providing an indication of the sender and the subject of the received email, but does not transmit the original Internet mail message or the modified WAP or HTML page to the wireless device. More particularly, the instant wireless message comprises a header field indicating the email address of the person that originated the Internet mail message and the subject of the message. Following the header, as explained above, the wireless message provides a link enabling the wireless client machine to access the WAP or HTML page file associated with the original Internet mail message that in turn was used to generate the instant wireless message. Once again, the link provided on the instant message is entirely unique to that particular message. Thus, for each new Internet mail message received by server 10, a unique link is generated addressing (e.g., via generation of a URL as is well known in the art) the WAP or HTML pages that are generated on server 10 from that specific Internet mail message, and that specific link is written to the instant mail message associated with that particular WAP or HTML file it is intended to address.

As explained above, whether the wireless device accesses a WAP version or an HTML version of the message page(s) generated from the original Internet mail message depends on the operating system used by the wireless machine, i.e., whether the machine employs a WAP-capable browser or an HTML-capable browser. When the link is activated (e.g., by “clicking” on the link using a pointing device, as is well known in the art), the wireless client machine transmits to server 10 a request to receive the WAP or HTML page file located at the address identified by the unique link, which is likewise the file associated with the instant wireless message then being viewed. In response to receiving such request from a wireless client machine, server 10 then transmits to the wireless client machine the WAP or HTML pages located at that specific address, which pages again include the modified version of the Internet mail message originally transmitted to server 10, thus enabling the user to view the modified version of that original mail message (with attachments) on their wireless client machine.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A method for communicating email messages to remote users of wireless devices, comprising the steps of:
a. checking for new email on a plurality of mail accounts associated with a plurality of remote users of wireless devices;
b. receiving new email from at least one client mail server;
c. storing new email in a database with an identifier associating said new email with a particular remote user;
d. transforming any attachments to said email into WAP-viewable pages;
e. preparing said email for viewing via WAP or WEB; and
f. sending said particular remote user notification about a new email message via SMS, MMS, EMS, or WAP PUSH.

2. A system for enabling the user of a wireless device to remotely access a modified version of an Internet email message through a link provided in a low bandwidth message transmitted to the wireless device, comprising:
a computer hosting an email service accessible via wireless devices to a plurality of remote users, said email service being operable to:
a. receive Internet mail from at least one Internet mail server;
b. process the received mail into a modified message and store said modified message in a format in which the message and any attachments thereto may be read, viewed, heard, and accessed on a remote wireless client machine;
c. transmit a summary of the received Internet Mail message with a link to said modified message to a wireless client machine associated with a user identified in said received mail; and
d. communicate with said wireless client machine to allow secure access from said wireless client machine to said modified message without requiring a user logon procedure.
